(19) United States
(12) Patent Application Publication
(10) Pub. No.: US 2026/0038014 A1
(43) Pub. Date: Feb. 5, 2026

(54) SYSTEM AND METHOD TO PERSONALIZE A SHOPPING EXPERIENCE IN A CONVERSATIONAL COMMERCE PLATFORM

(71) Applicant: NewEcom.AI, Mamaroneck, NY (US)

(72) Inventors: Francois Silvain, Winchester, MA (US); Frederic Levy, Brooklyn, NY (US); Radu Gabriel Buta, Mamaroneck, NY (US)

(21) Appl. No.: 18/790,399

(22) Filed: Jul. 31, 2024

(51) Int. Cl. G06Q 30/0601; G06F 40/58

(52) U.S. Cl. CPC G06Q 30/0617; G06F 40/58; G06Q 30/0603

(57) ABSTRACT

A system to personalize a shopping experience in a conversational commerce platform is disclosed. The system includes a processing subsystem having a user interface module for consumer input and an input conversion module that processes and translates this input using a large language model (LLM) engine. The engine module features a catalog facet creation module that structures product information, a facet enrichment module for detailed descriptions, images and buyers' profile, and a customer profiling module utilizing natural language processing to understand customer needs. An AI merchandising module presents optimal product facets to customers based on profiles and historical data. Additionally, a conversational commerce module facilitates product selection through guided conversations, while a personalization module tailors recommendations. The system also includes a data collection and analytics module for performance tracking and a training and optimization module for continuous improvement of the LLM.

### FIELD OF INVENTION

Embodiments of the present disclosure relate to the field of e-commerce and artificial intelligence, and more particularly to, a system and a method to personalize a shopping experience in a conversational commerce platform.

### BACKGROUND

In conventional e-commerce systems, the personalization of the shopping experience is primarily achieved through methods such as collaborative filtering, rule-based recommendations, and demographic targeting. These techniques, while effective to a certain extent, have notable limitations.

Collaborative filtering: This technique is based on the idea that users with similar behaviour and preferences will like similar products. It works by analysing the past behaviour of a large number of users and finding patterns. For example, if User A and User B both liked Product X, and User A also liked Product Y, then the system might recommend Product Y to User B. While collaborative filtering can generate useful recommendations, it relies heavily on historical data. This dependency means that it may not effectively capture a user's current intent, interests, or contextual needs. Additionally, it struggles with the “cold start” problem, where it cannot provide good recommendations for new users or new products due to a lack of data.

Rule-based systems: These systems use predefined rules set by marketers or system administrators to recommend products. For instance, a rule might state that if a user buys a camera, they should also be shown camera accessories like lenses or tripods. While rule-based systems can be useful for straightforward and predictable recommendation scenarios, they lack flexibility and adaptability. These systems do not learn or evolve from user interactions, and the static nature of the rules means they cannot easily adjust to changing user preferences or new product trends.

Demographic targeting: This method involves segmenting users based on demographic information such as age, gender, location, and sometimes income level. Products and recommendations are then tailored to these segments. For example, young adults might be shown trendy fashion items, while older adults might be shown more classic styles. However, demographic targeting can often result in broad generalizations that do not accurately capture individual user preferences. It can lead to a less personalized experience as it does not consider the unique tastes and behaviours of each user.

Despite the implementation of these methods, conventional e-commerce systems often fail to deliver a highly personalized and engaging shopping experience. The limitations of these systems are particularly pronounced in today's competitive e-commerce landscape, where customer expectations for personalization are higher than ever. Furthermore, the rise in Customer Acquisition Costs (CAC) and shipping and logistic expenses, coupled with stringent privacy laws, make it increasingly challenging for businesses to identify and engage customers effectively. As a result, e-commerce platforms struggle to enhance key performance indicators such as Average Order Value (AOV) and Conversion Rates. Without a more advanced approach to personalization, e-commerce businesses face stagnation and diminishing returns, making it difficult to differentiate themselves and achieve sustainable growth.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of a system to personalize a shopping experience in a conversational commerce platform in accordance with an embodiment of the present disclosure;

FIG. 2 is a block diagram of a computer or a server in accordance with an embodiment of the present disclosure;

FIG. 3 is a flow chart representing the steps involved in a method for personalizing a shopping experience in a conversational commerce platform of FIG. 1 in accordance with an embodiment of the present disclosure; and

FIG. 4 is a flow chart representing the steps involved in an exemplary method for personalizing a shopping experience in a conversational commerce platform of FIG. 3 in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to the field of e-commerce and artificial intelligence, and more particularly to, a system and a method to personalize a shopping experience in a conversational commerce platform. In the contemporary e-commerce landscape, businesses face significant challenges in maintaining profitability due to the rising Customer Acquisition Costs (CAC) and escalating shipping and logistics expenses. As customer expectations evolve, there is a pressing need to enhance the Average Order Value (AOV) and Conversion Rates to maximize the value derived from each customer visit. However, traditional methods of personalization, such as collaborative filtering, rule-based systems, and demographic targeting, fall short in delivering a deeply personalized shopping experience. These methods often rely on historical data and predefined rules, which fail to adapt to the dynamic and nuanced preferences of individual users. Additionally, stringent privacy laws and changing consumer behaviours limit the opportunities for businesses to identify and engage customers effectively. As a result, e-commerce performance remains stagnant, with businesses struggling to differentiate themselves and achieve sustainable growth. The current landscape underscores the necessity for a radical overhaul in how online shopping experiences are designed and delivered, emphasizing the need for innovative solutions that offer hyper-personalized interactions and targeted recommendations.

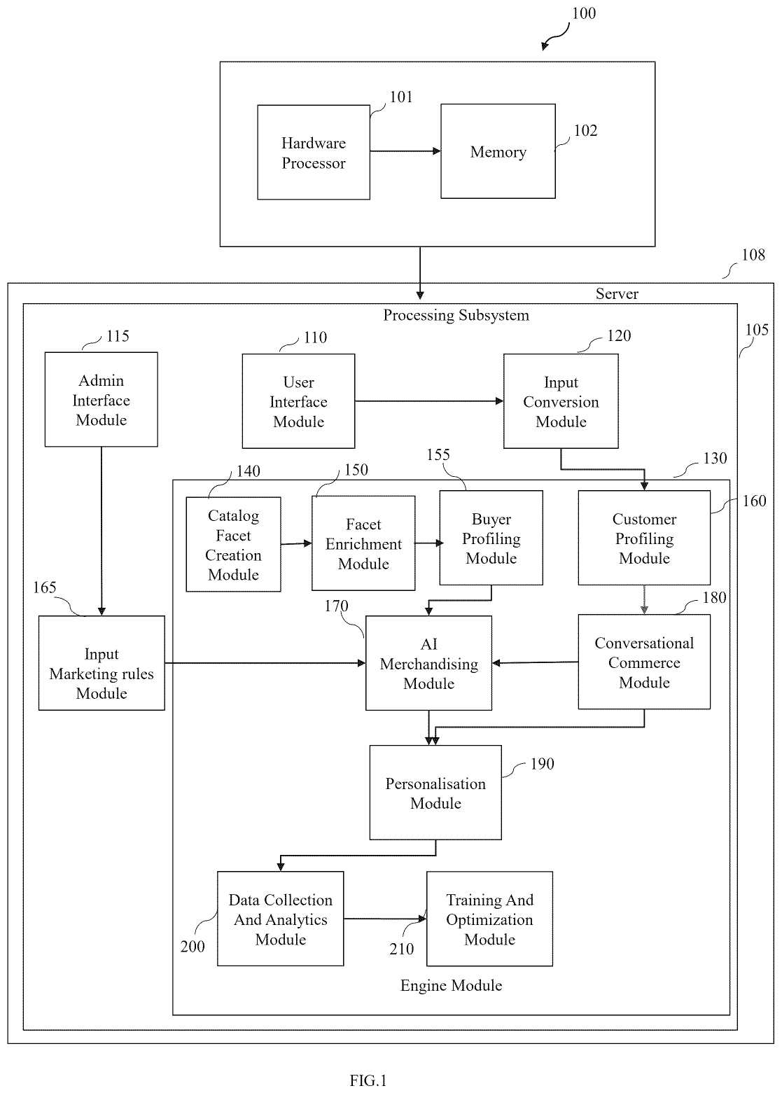

FIG. 1 is a block diagram of a system 100 to personalize a shopping experience in a conversational commerce platform in accordance with an embodiment of the present disclosure. The system 100 includes a hardware processor 101 and a memory 102 coupled to the hardware processor 101. The memory 102 includes a set of program instructions in the form of a processing subsystem 105 and configured to be executed by the hardware processor 101. As used herein, the hardware processor performs data processing, decision making, and all general computing tasks and coordinates tasks done by memory, disk storage, and other system components. The processing subsystem 105 is hosted on a sever 108. In one embodiment, the server 108 may include a cloud server. In another embodiment, the server 108 may include a local server. The processing subsystem 105 is configured to execute on a network (not shown in FIG. 1) to control bidirectional communications among a plurality of modules. In one embodiment, the network may include a wired network such as local area network (LAN). In another embodiment, the network may include a wireless network such as Wi-Fi, Bluetooth, Zigbee, near field communication (NFC), infra-red communication (RFID) or the like.

The processing subsystem 105 includes a user interface module 110 configured to receive input from consumers through an e-commerce platform. The user interface module 110 is a sophisticated component designed to receive and handle various types of consumer inputs within an e-commerce platform, providing a seamless interaction experience that facilitates the collection of detailed and precise consumer needs. This module supports multi-input reception capabilities, including text, voice, and visual inputs. The text input interface allows consumers to enter search queries, product preferences, and descriptions of their needs using natural language, while the integrated voice recognition technology enables interaction through spoken language, converting voice commands to text via a speech-to-text engine. Additionally, the module includes a visual input interface that allows consumers to upload relevant images or videos, which are processed using visual recognition algorithms to extract pertinent features and attributes.

Once input is received, the user interface module 110 formats the data into a standardized payload, encapsulating the input type along with necessary metadata, such as timestamps and contextual information. It also includes pre-processing capabilities to clean and normalize the data, applying techniques such as noise reduction for voice input and visual enhancement for visual input.

Built with a responsive design framework, the user interface module 110 ensures compatibility across various devices, enhancing accessibility and usability. It includes interactive elements like auto-suggestions for text input, voice command prompts, and image or video upload guidelines to guide consumers through the input process, improving the overall user experience. The module incorporates robust security measures, including data encryption, secure handling of files, and compliance with privacy regulations such as GDPR and CCPA. It also supports user authentication and authorization mechanisms to ensure that only authorized consumers can access and interact with the input interfaces. Overall, the user interface module 110 is a versatile and integral part of the e-commerce platform, critical for enhancing the personalization of the shopping experience through its advanced capabilities and focus on user experience and security.

Also, the processing subsystem 105 includes an input conversion module 120 configured to receive a payload from the user interface module, process the input, and translate processed input into characteristics, attributes and qualifiers using a large language model (LLM) engine. The input conversion module 120 is designed to interact seamlessly with the user interface module 110 to manage and process user input efficiently. The input conversion module 120 receives a payload, which encapsulates the raw data or queries inputted by users through various interface channels such as web, mobile, or voice-activated devices. The input conversion module 120 then processes this payload, extracting and structuring relevant information from the received data. Utilizing an advanced large language model (LLM) engine, the input conversion module 120 translates the processed input into coherent, actionable characteristics, attributes and qualifiers. This transformation involves natural language processing techniques to interpret and convert user queries into a standardized format that can be further analysed and utilized by downstream modules in the system. The LLM engine's capabilities enable the input conversion module 120 to handle complex and varied inputs with high accuracy, ensuring that user interactions are effectively captured and understood for subsequent personalization and recommendation tasks.

Also, the processing subsystem 105 includes an admin interface module 115 configured to receive input from administrator. The admin interface module 115 is designed to receive and handle various types of admin inputs, providing a seamless interaction experience that facilitates the configuration of the marketing rules.

Furthermore, the processing subsystem 105 includes an engine module 130. The engine module 130 is a sophisticated system component integral to the personalized shopping experience platform. The engine module 130 encompasses the catalog facet creation module 140, which plays a pivotal role in enhancing product discoverability and relevance. This module is configured to inject comprehensive product catalog data, including structural elements, characteristics, and detailed descriptions, into a Large Language Model (LLM). The primary function of the catalog facet creation module 140 is to leverage the LLM's advanced capabilities to generate multiple facets of the product catalog. A facet represents a logical grouping of products based on shared attributes such as type, usage, material, or condition. By encoding the catalog data into the LLM, the catalog facet creation module 140 facilitates the automatic creation of a large variety of facets representing different view of the catalog, which are essential for delivering a highly personalized shopping experience. This facet generation process enables the system to categorize and organize products in a manner that aligns with user preferences and enhances search and recommendation accuracy, thereby significantly improving the overall efficacy of the e-commerce platform.

Also, the engine module 130 includes a facet enrichment module 150 configured to enrich each facet with detailed descriptions, keywords, metadata, and images generated from textual descriptions using a neural network-based model. The facet enrichment module 150 is designed to enrich each facet by integrating detailed descriptions, relevant keywords, and metadata, thereby providing a richer context for each product grouping. It utilizes a neural network-based model to generate images from textual descriptions, adding a visual dimension to the facets that enhances user engagement and product visualization. By processing the textual descriptions through this advanced neural network, the facet enrichment module 150 produces high-quality images that accurately represent the products within each facet. The incorporation of detailed descriptions and metadata further refines each facet's relevance and searchability, ensuring that users receive well-rounded, informative content that aligns with their needs and preferences. This enrichment process significantly contributes to a more immersive and effective personalized shopping experience by improving both the textual and visual representation of products.

Also, the engine module 130 includes a buyer profiling module 155. The buyer profiling module 155 is configured to generate typical buyer profiles for each generated facet. The buyer profiling module 155 is also configured to inject facet data, including structural elements, characteristics, and detailed descriptions, into a Large Language Model (LLM). By encoding the facet data into the LLM, the buyer profiling module 155 facilitates the automatic creation of a buyer profiles representing the typical buyer personas for each facet, which are essential for enabling marketing targeting.

In addition, the engine module 130 includes a customer profiling module 160 configured to profile customers based on natural language input or guided conversation and to understand customer needs using on of natural language processing, voice processing, or visual recognition techniques. The customer profiling module 160 utilizes a combination of advanced techniques to profile customers based on their natural language input or guided conversation. By employing natural language processing (NLP), voice processing, and visual recognition techniques, the customer profiling module 160 effectively interprets and understands diverse forms of customer input. NLP enables the customer profiling module 160 to analyse and extract meaningful insights from textual communications, while voice processing techniques facilitate the interpretation of spoken queries and responses. Additionally, visual recognition capabilities allow the customer profiling module 160 to identify and assess customer needs through visual inputs, such as images or video. This multifaceted approach ensures a comprehensive understanding of customer preferences, behaviours, and requirements, thereby enabling the system to deliver highly tailored and relevant shopping experiences. The insights gathered are used to build detailed customer profiles that enhance personalization and improve interaction outcomes throughout the shopping journey.

Further, the processing subsystem 105 includes an input marketing rules module 165 configured to receive a payload from the admin interface module, process the input, and translate processed input into characteristics, attributes and qualifiers of marketing rules. The marketing rules module 165 enables the administrator to set targeting rules promoting products and promotions to customer matching customer segment, buyer's profile or archetype of customer's need.

Also, the engine module 130 includes an artificial intelligence (AI) merchandizing module 170 configured to determine and present best facets of the catalog to the customer based on their profile, historical data, and expressed needs. The artificial intelligence (AI) merchandizing module 170 leverages advanced AI algorithms to analyse and integrate customer profiles, historical data, and expressed needs. As used herein, the term “facet” refers to a logical grouping of products based on attributes such as type, usage, or material. The artificial intelligence (AI) merchandizing module 170 utilizes these facets to match the most relevant product groupings with the individual customer's profile, which includes their preferences, behaviours, and historical interactions. Historical data encompasses past purchases, browsing behaviour, and other relevant interactions that provide insights into customer preferences. The expressed needs are derived from real-time inputs and interactions, such as queries, answers or feedback. By synthesizing these data points, the AI merchandising module 170 determines and presents the best-suited facets from the catalog, ensuring that the recommendations align with the customer's profile and current requirements. The AI merchandising module 170 matches the customer's profile with the customer segments, the buyer's profiles or archetype of customer need and injects in the answer featured products and promotions as configured in the Input marketing rules module 165. This tailored approach aims to increase user satisfaction and drive higher engagement and conversion rates by presenting the most relevant and compelling product options to each customer.

In addition, the engine module 130 includes a conversational commerce module 180 configured to enable customers to interact with a virtual assistant to find, choose, and purchase products through guided conversation. The conversational commerce module 180 leverages conversational interfaces to allow customers to engage with a virtual assistant, which uses natural language processing (NLP) to understand and respond to user inputs. The virtual assistant guides customers through the process of finding, choosing, and purchasing products, effectively simulating a personalized shopping assistant experience. This interaction occurs within a chat-based or voice-based interface, where the assistant helps users navigate product catalogs, make informed decisions, and complete transactions. The conversational commerce module 180 ensures that the conversation is contextually relevant and responsive to the customer's needs, preferences, and queries. By employing guided conversation techniques, the conversational commerce module 180 streamlines the shopping journey, reduces friction in the decision-making process, and enhances overall user satisfaction. This approach aims to replicate the benefits of in-store shopping by providing personalized recommendations and support in a digital format, thus improving customer engagement and conversion rates.

Furthermore, the engine module 130 includes a personalization module 190 configured to request and present the best facets, categories, and products to customers based on their profile and needs. The personalization module 190 operates by utilizing a customer's profile and expressed needs to tailor the shopping experience. As used herein, the term “profile” in this context refers to a comprehensive aggregation of customer data, including preferences, behaviours, and historical interactions, while “needs” are the specific requirements or desires expressed by the customer during their interaction with the system. The personalization module 190 processes this data to identify and request the most relevant facets, categories, and products from the catalog. The term “categories” represent broader classifications within the catalog. By analysing the customer's profile and needs, the personalization module 190 dynamically selects and presents the most appropriate facets, categories, and products, ensuring that the recommendations are highly relevant and tailored to each individual. This targeted approach aims to enhance user satisfaction and increase conversion rates by aligning product suggestions with the customer's specific interests and requirements.

The engine module 130 also includes a data collection and analytics module 200 configured to track conversations and navigation, analyse performance, and generate data for optimization. The data collection and analytics module 200 is configured to systematically track conversations and navigation patterns within the conversational commerce platform. As used herein, the term “conversations” refer to the exchanges between customers and the virtual assistant, and “navigation” involves the paths taken by users through the e-commerce interface. The data collection and analytics module 200 aggregates data on these interactions to assess performance metrics such as user engagement, conversion rates, and effectiveness of product recommendations. Using advanced analytical techniques, the data collection and analytics module 200 processes this data to generate actionable insights, which are essential for identifying trends, understanding user behaviour, and detecting areas for improvement. These insights are then utilized to refine and optimize system functionalities, including personalization algorithms and user interface elements, to enhance the overall shopping experience. The data collected and analysed by this module plays a crucial role in driving continuous improvement and ensuring that the system adapts effectively to evolving user needs and preferences.

Furthermore, the engine module 130 includes a training and optimization module 210 configured to enable administrators to fine-tune the large language model (LLM) based on insights generated from data analytics and to reevaluate facets and merchandizing using the updated large language model (LLM). As used herein, the term “insights” refer to the actionable findings obtained from evaluating user interactions, performance metrics, and system data. Fine-tuning involves adjusting the LLM's parameters and algorithms to improve its ability to generate relevant and contextually accurate responses based on updated information. Additionally, the training and optimization module 210 facilitates the re-evaluation of product facets and merchandising strategies by leveraging the updated LLM. Also, the term “merchandising” involves the strategies used to present and promote products. By applying the refined LLM to these elements, the training and optimization module 210 ensures that product categorizations and promotional tactics remain aligned with current customer preferences and trends. This ongoing process of training and optimization ensures that the system continuously evolves and improves, providing a more personalized and effective shopping experience.

In one exemplary embodiment, the engine module 130 may include a historical data enrichment module which may be designed to enhance customer profiles by incorporating and analysing historical data. This module integrates historical information such as Customer Relationship Management (CRM) data and transactional records to identify patterns and trends in customer behaviour. It processes this data to enrich customer profiles with additional insights, including demographic, psychographic, and behavioural characteristics. By leveraging historical data, the module improves the accuracy and depth of customer profiles, which in turn enhances the system's ability to deliver personalized recommendations and targeted marketing. This enriched data helps in understanding customer preferences and predicting future needs, thus optimizing the overall shopping experience and marketing effectiveness.

In another exemplary embodiment, the engine module 130 may also include a marketing rules module which enables the definition and application of targeted marketing strategies within the e-commerce platform. This module allows marketing teams to create and configure rules that govern the promotion of specific product categories, products, or special offers. The rules are based on various criteria such as customer segments, buyer profiles, and archetypes of customer needs. By leveraging these rules, the module determines how and when to feature products and promotions to maximize their relevance and impact. It ensures that marketing efforts are aligned with the identified customer profiles and preferences, enhancing the effectiveness of promotional campaigns and improving customer engagement and conversion rates.

In one embodiment, considering a real time scenario where a customer, Sarah, visiting an online e-commerce platform to buy a new laptop. As Sarah interacts with the platform, the user interface module 110 receives her input, including her preference for a lightweight laptop suitable for graphic design. The input conversion module 120 processes this information, converting her needs into actionable text using a large language model (LLM) engine.

The engine module 130 then springs into action. The catalog facet creation module 140 organizes the laptop catalog into facets like “lightweight laptops,” “graphic design laptops,” and “high-performance laptops.” Each facet is enriched by the facet enrichment module 150, which adds detailed descriptions, relevant keywords, and images generated from textual descriptions.

The customer profiling module 160 assesses Sarah's preferences based on her input and any historical data, creating a detailed profile. The AI merchandising module 170 uses this profile to determine which facets, like “best lightweight laptops for graphic design,” align with her needs. The conversational commerce module 180 then enables Sarah to interact with a virtual assistant, guiding her through the available options.

The personalization module 190 presents Sarah with the most relevant facets, categories, and products, highlighting top recommendations based on her profile and needs. As Sarah navigates and interacts with the virtual assistant, the data collection and analytics module 200 tracks her conversations and navigation patterns, analysing performance and gathering insights for optimization.

Finally, the training and optimization module 210 allows administrators to fine-tune the LLM based on the insights gathered, ensuring that future interactions are even more personalized and effective. This continuous loop of interaction, data collection, and model optimization ensures that Sarah receives a tailored, efficient shopping experience, ultimately making her purchase decision smoother and more satisfying.

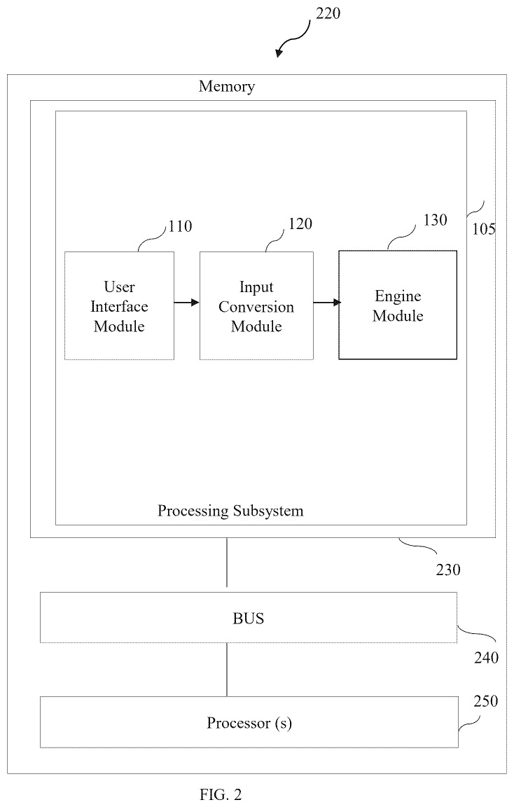

FIG. 2 is a block diagram of a computer or a server in accordance with an embodiment of the present disclosure. The server 220 includes processor(s) 250, and memory 230 operatively coupled to the bus 240. The processor(s) 250, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 230 includes several subsystems stored in the form of executable program which instructs the processor 250 to perform the method steps illustrated in FIG. 1. The memory 230 includes a processing subsystem 105 of FIG. 1. The processing subsystem 105 further has following modules: a user interface module 110, an input conversion module 120, an admin interface module 115, an engine module 130, a catalog facet creation module 140, a facet enrichment module 150, a buyer's profile module 155, a customer profiling module 160, an input marketing rules module 165, an artificial intelligence (AI) merchandizing module 170, a conversational commerce module 180, a personalization module 190, a data collection and analytics module 200 and a training and optimization module 210.

The user interface module 110 configured to receive input from consumers through an e-commerce platform. The input conversion module 120 is configured to receive a payload from the user interface module, process the input, and translate processed input into text using a large language model (LLM) engine. The admin interface module 115 is configured to receive input from administrators. The catalog facet creation module 140 is configured to inject product catalog structure, characteristics, and descriptions into a large language model (LLM) to create multiple facets of the catalog. The facet enrichment module 150 is configured to enrich each facet with detailed descriptions, keywords, metadata, and images generated from textual descriptions using a neural network-based model. The Buyer profiling module 155 is configured to profile the typical buyer of each created facts. The customer profiling module 160 is configured to profile customers based on natural language input or guided conversation and to understand customer needs using on of natural language processing, voice processing, or visual recognition techniques. The input marketing rules module 165 is configured to associate featured products and promotions with buyer's profiles, customer segments or archetypes of customer needs. The artificial intelligence (AI) merchandizing module 170 is configured to determine and present best facets of the catalog to the customer based on their profile, historical data, and expressed needs and determine and present the best featured products and promotions based on the customer's profile its match with either the customer segments, buyers' profile or archetype of customer need. The conversational commerce module 180 is configured to enable customers to interact with a virtual assistant to find, choose, and purchase products through guided conversation. The personalization module 190 is configured to request and present the best facets, categories, and products to customers based on their profile and needs. The data collection and analytics module 200 is configured to track conversations and navigation, analyse performance, and generate data for optimization. The training and optimization module 210 is configured to enable administrators to fine-tune the large language model (LLM) based on insights generated from data analytics and to reevaluate facets and merchandizing using the updated large language model (LLM).

The bus 240 as used herein refers to be internal memory channels or computer network that is used to connect computer components and transfer data between them. The bus 240 includes a serial bus or a parallel bus, wherein the serial bus transmits data in bit-serial format and the parallel bus transmits data across multiple wires. The bus 240 as used herein, may include but not limited to, a system bus, an internal bus, an external bus, an expansion bus, a frontside bus, a backside bus and the like.

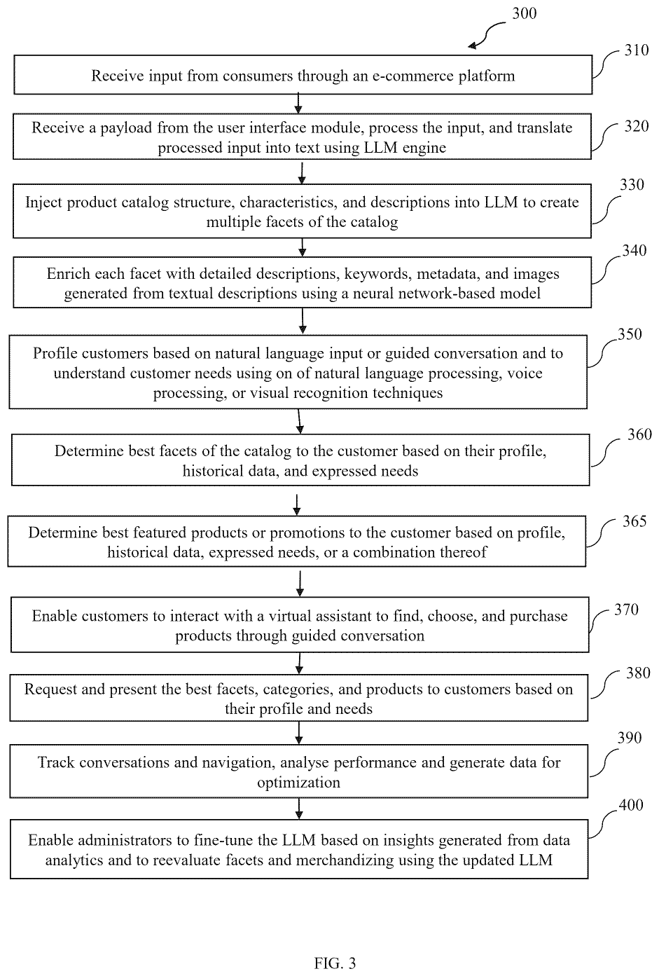

FIG. 3 is a flow chart representing the steps involved in a method for personalizing a shopping experience in a conversational commerce platform of FIG. 1 in accordance with an embodiment of the present disclosure. The method 300 includes receiving input from consumers through an e-commerce platform in step 310.

The method 300 also includes receiving a payload from the user interface module, process the input, and translate processed input into text using a large language model (LLM) engine in step 320. More specifically, the method 300 involves receiving a payload from the user interface module, which captures input from consumers through an e-commerce platform. This input is then processed and translated into text using a large language model (LLM) engine. This translation step leverages advanced natural language processing capabilities to accurately interpret and convert user input into actionable text, facilitating subsequent stages of the e-commerce process. This method ensures that consumer interactions are effectively transformed into meaningful data that can be utilized for personalized product recommendations and enhanced customer experiences.

The method 300 further includes injecting product catalog structure, characteristics, and descriptions into a large language model (LLM) to create multiple facets of the catalog in step 330. More specifically, the method 300 includes injecting product catalog structure, characteristics, and descriptions into a large language model (LLM) to create multiple facets of the catalog. This step involves structuring the catalog data in a way that the LLM can interpret and utilize, ensuring that each product is represented with detailed descriptions, attributes, and relevant metadata. By generating multiple facets, the LLM can provide a more comprehensive and nuanced understanding of the product catalog, enabling more precise and personalized recommendations and search results for consumers. This facet creation process enhances the overall effectiveness of the e-commerce platform in delivering tailored shopping experiences.

Furthermore, the method 300 includes enriching each facet with detailed descriptions, keywords, metadata, and images generated from textual descriptions using a neural network-based model in step 340. More specifically, the method 300 includes enriching each facet of the product catalog with detailed descriptions, keywords, metadata, and images generated from textual descriptions using a neural network-based model. This enrichment process leverages advanced neural networks to analyse and enhance the textual data, ensuring that each facet is comprehensive and informative. By adding rich metadata and visually representative images, the method improves the searchability and appeal of the products, providing consumers with a more engaging and accurate representation of the catalog. This step is crucial for optimizing the product presentation and enhancing the overall user experience on the e-commerce platform.

The method 300 also includes profiling customers based on natural language input or guided conversation and to understand customer needs using on of natural language processing, voice processing, or visual recognition techniques in step 350. More specifically, the method 300 includes profiling customers based on natural language input or guided conversation and understanding their needs using natural language processing, voice processing, or visual recognition techniques. This step involves collecting and analysing data from various forms of customer interactions to create detailed profiles. By leveraging advanced technologies, the system can accurately interpret customer preferences and requirements, enabling a more personalized and responsive shopping experience. This profiling process is essential for tailoring recommendations and improving customer satisfaction on the e-commerce platform.

Also, the method 300 includes determining best facets of the catalog to the customer based on their profile, historical data, and expressed needs in step 360. More specifically, the method 300 includes determining the most suitable facets of the product catalog for the customer by integrating their profile, historical data, and expressed needs. This method starts with analysing the customer's profile, which includes their preferences and behaviours. It then incorporates historical data, such as previous purchases and interactions, to enhance understanding of their preferences. Additionally, the method assesses the customer's current expressed needs, which are derived from their recent queries, answers or feedback. By combining these elements, the method identifies and selects the most relevant product facets that match the customer's specific interests and requirements, thereby delivering a highly personalized and relevant shopping experience.

Also, the method 300 includes determining best featured products and promotions for the customer based on profile, historical data, expressed needs, or a combination thereof in step 365. More specifically, the method 300 includes determining the most suitable featured products or promotions for the customer by integrating their profile, historical data, and expressed needs. This method starts with analysing the customer's profile, which includes their preferences and behaviours. It then incorporates historical data, such as previous purchases and interactions, to enhance understanding of their preferences. Additionally, the method 300 assesses the customer's current expressed needs, which are derived from their recent queries, answers or feedback. By combining these elements, the method 300 identifies and selects the most relevant featured products or promotions that match customer segment, buyers' profiles or archetypes of need defined in the input marketing rules module, thereby delivering a highly personalized and relevant recommendation and promotion.

The method 300 also includes enabling customers to interact with a virtual assistant to find, choose, and purchase products through guided conversation in step 370. More specifically, the method 300 includes enabling customers to interact with a virtual assistant to find, choose, and purchase products through guided conversation. The virtual assistant utilizes natural language processing and contextual understanding to engage in meaningful dialogue with customers, helping them navigate the product catalog, make informed choices, and complete transactions. By guiding the conversation based on the customer's profile, preferences, and expressed needs, the assistant provides personalized recommendations and support, streamlining the shopping process and enhancing the overall user experience.

The method 300 also includes requesting and presenting the best facets, categories, and products to customers based on their profile and needs in step 380. More specifically, the method 300 includes enabling customers to interact with a virtual assistant to find, choose, and purchase products through a guided conversation. This involves leveraging a conversational interface where the virtual assistant engages with the customer, guiding them through the product discovery and selection process. The assistant uses natural language processing to understand and respond to customer queries, provide personalized recommendations, and facilitate the purchasing process. By managing the conversation and presenting relevant product facets based on the customer's profile, historical data, and expressed needs, the virtual assistant ensures a seamless and tailored shopping experience.

Furthermore, the method 300 tracking conversations and navigation, analyse performance and generate data for optimization in step 390. More specifically, the method 300 includes tracking customer conversations and navigation patterns within the e-commerce platform, analysing performance metrics, and generating data for optimization. This process captures detailed interactions between customers and the virtual assistant, including the paths customers take through the platform. The collected data is analysed to evaluate the effectiveness of personalization, recommendations, and overall user experience. Insights gained from this analysis are used to refine and enhance system performance, ensuring that future interactions are more effective and tailored to customer needs.

The method 300 further includes enabling administrators to fine-tune the large language model (LLM) based on insights generated from data analytics and to reevaluate facets and merchandizing using the updated large language model (LLM) in step 400. More specifically, the method 300 includes enabling administrators to fine-tune the large language model (LLM) based on insights generated from data analytics. This involves adjusting the LLM's parameters and algorithms to improve its performance and accuracy, reflecting the latest data and trends. Administrators use these insights to reevaluate and update the facets and merchandising strategies, ensuring that product categorizations and promotional tactics remain aligned with current customer preferences and behaviours. This ongoing optimization process enhances the system's ability to deliver a more personalized and effective shopping experience.

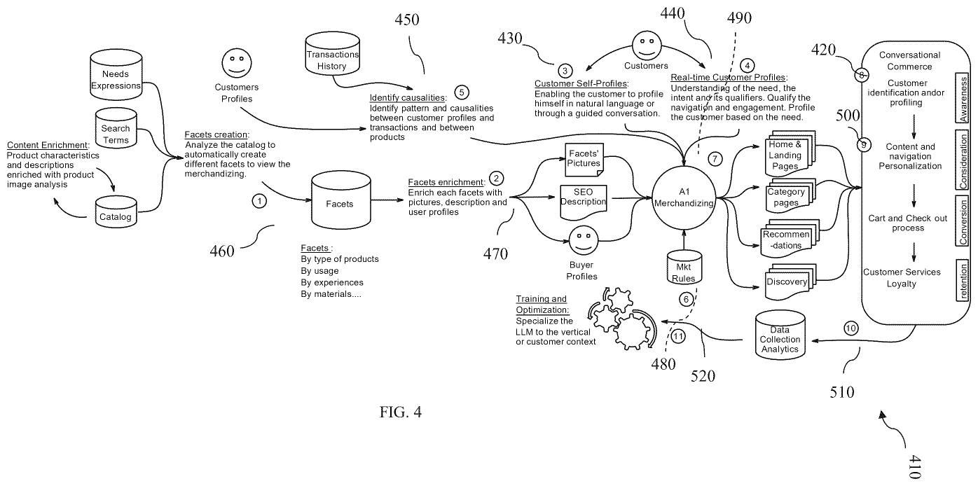

FIG. 4 is a flow chart representing the steps involved in another exemplary method for personalizing a shopping experience in a conversational commerce platform of FIG. 3 in accordance with an embodiment of the present disclosure.

In a highly competitive e-commerce environment, businesses face rising Customer Acquisition Costs (CAC) and increasing logistics expenses. To maximize customer value during site visits, there is a need to focus on improving Average Order Value (AOV) and Conversion Rates. Evolving privacy laws and changes in consumer behavior make customer identification and personalization challenging. Without innovative changes to online shopping experiences, e-commerce businesses risk stagnation and diminishing returns. The outlined method 410 leverages conversational commerce and advanced AI techniques to deliver hyper-personalized shopping experiences, ultimately enhancing KPIs and sustaining growth.

The process begins with structuring the product catalog into facets, logical groups of products defined by various characteristics such as type, usage, experience, and material in step 420. Large Language Models (LLMs) automatically generate these facets, enabling detailed personalization in step 430. Each facet is enriched with comprehensive descriptions, keywords, and metadata through the use of LLMs in step 440. Neural Network-Based models generate images from textual descriptions, and ideal buyer profiles are created for each facet in step 440. These profiles focus on interests, preferences, and purchasing capabilities while avoiding demographics and psychographics to prevent bias.

Customers profile themselves either through natural language input or guided conversations in step 450. LLMs interpret and detail customer characteristics and profiles, allowing for a deep understanding of each customer in step 450. Using Natural Language Processing (NLP), voice processing, or visual recognition, the system captures and comprehends customer needs, intents, and characteristics in step 455. This understanding is enhanced through continuous conversation tracking, resulting in a real-time, comprehensive profile of customer needs. LLMs periodically generate customer need archetypes to serve as target audiences in marketing strategies.

If available, historical data from CRM or transactional sources are integrated into models to identify patterns and causalities between customer profiles and transactions in step 460. When customers log in or opt-in through other methods, the system enriches profiles with demographic, psychographic, and behavioural data, enhancing the depth of customer understanding in step 460.

The marketing team defines rules to promote specific categories, products, or promotions to targeted audiences, such as customer segments or buyer profiles in step 470. These rules are incorporated into the method to ensure relevant promotions reach the appropriate customers. Customer profiles, enriched with historical data and current needs, are combined with facet descriptions and buyer profiles in step 480. LLMs process this combination to determine the most relevant facets to present to each customer in step 480. Marketing rules further refine the selection, featuring targeted categories, products, or promotions within the chosen facets in step 480.

The core of the method involves enabling customers to interact with a virtual assistant to find, choose, and purchase products through a conversational interface in step 490. This interaction differs from traditional browsing, as customers engage in a dialogue with the assistant. LLMs guide conversations, propose next steps, and anticipate questions. Customers express their needs, navigate personalized facets, ask product-related questions, receive tailored recommendations, and complete purchases within the chat interface in step 490.

The method continuously personalizes the shopping experience by presenting facets, categories, and products tailored to the customer's profile and needs in step 500. Featured items are highlighted within the conversation. As the conversation progresses, the method reevaluates and refines the facets based on updated customer needs and interactions in step 500.

All conversations and navigational data are tracked to evaluate the effectiveness of personalization and AI merchandising in step 510. This data is analyzed to generate insights for further training and optimization. Administrators access a user interface for fine-tuning LLM training and optimization based on insights from data analytics in step 520. The method reevaluates steps 420-460 with the optimized LLM, ensuring continuous improvement in personalization.

This method 410 aims to revolutionize e-commerce by offering deeply personalized shopping experiences through conversational commerce, utilizing advanced AI techniques, and continuous optimization based on customer interactions and data analytics. By associating specific steps with corresponding blocks, the method ensures a structured and efficient approach to enhancing customer satisfaction and business performance.

Various embodiments of the present invention provide a system which offers significant advantages by revolutionizing the shopping experience through personalization and advanced merchandising techniques. By leveraging real-time customer profiles and dynamic data enrichment, it ensures that customers receive tailored product recommendations that align with their individual preferences and shopping behaviours. This level of personalization enhances customer satisfaction and engagement, leading to increased loyalty and repeat purchases. The integration of conversational commerce further simplifies the shopping process, providing a seamless and intuitive interface for customers to interact with, thereby improving accessibility and convenience.

Additionally, the system's ability to continuously update and refine product listings based on customer interactions ensures that the merchandise remains relevant and appealing. This adaptive approach not only boosts sales but also optimizes inventory management by highlighting the most sought-after products. Overall, the invention enhances the efficiency and effectiveness of the shopping.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A computer implemented system to personalize a shopping experience in a conversational commerce platform, wherein the system comprising:
a hardware processor; and
a memory coupled to the hardware processor, wherein the memory comprises a set of program instructions in the form of a processing subsystem, configured to be executed by the hardware processor, wherein the processing subsystem is hosted on a server and configured to execute on a network to control bidirectional communications among a plurality of modules comprising:
a user interface module configured to receive input from consumers through an e-commerce platform;
an input conversion module configured to receive a payload from the user interface module, process the input, and translate processed input into text using a large language model (LLM) engine;
an engine module comprising:
a catalog facet creation module configured to inject product catalog structure, characteristics, and descriptions into a large language model (LLM) to create multiple facets of the catalog;
a facet enrichment module configured to enrich each facet with detailed descriptions, keywords, metadata, and images generated from textual descriptions using a neural network-based model;
a buyer profiling module configured to inject facet characteristics, and descriptions into a large language model (LLM) to create a typical buyer profile for each facet created;
a customer profiling module configured to profile customers based on natural language input or guided conversation and to understand customer needs using on of natural language processing, voice processing, or visual recognition techniques;
an artificial intelligence (AI) merchandizing module configured to determine and present best facets of the catalog and best featured products and promotions to the customer based on their profile, historical data, and expressed needs;
a conversational commerce module configured to enable customers to interact with a virtual assistant to find, choose, and purchase products through guided conversation;
a personalization module configured to request and present the best facets, categories, and products to customers based on their profile and needs;
a data collection and analytics module configured to track conversations and navigation, analyze performance, and generate data for optimization; and
a training and optimization module configured to enable administrators to fine-tune the large language model (LLM) based on insights generated from data analytics and to reevaluate facets and merchandizing using the updated large language model (LLM).

2. The system of claim 1, wherein the user interface module is configured to receive input from at least one of multiple platforms, wherein the multiple platforms comprise web, mobile, voice-activated devices, or a combination thereof.

3. The system of claim 1, wherein the catalog facet creation module uses clustering techniques to group similar products into facets.

4. The system of claim 1, wherein the facet enrichment module utilizes pre-trained image generation models for generating images from textual descriptions.

5. The system of claim 1, wherein the customer profiling module integrates real-time customer feedback to refine profiles.

6. The system of claim 1, wherein the artificial intelligence (AI) merchandizing module incorporates seasonal trends and events into facet presentation.

7. The system of claim 1, wherein the data collection and analytics module provide a dashboard for visualizing key performance indicators.

8. A method for personalizing a shopping experience in a conversational commerce platform, wherein the method comprising:
receiving, by a user interface module, input from consumers through an e-commerce platform;
receiving, by an input conversion module, a payload from the user interface module, process the input, and translate processed input into text using a large language model (LLM) engine;
injecting, by a catalog facet creation module, product catalog structure, characteristics, and descriptions into a large language model (LLM) to create multiple facets of the catalog;
enriching, by a facet enrichment module, each facet with detailed descriptions, keywords, metadata, and images generated from textual descriptions using a neural network-based model;
profiling, by a customer profiling module, customers based on natural language input or guided conversation and to understand customer needs using on of natural language processing, voice processing, or visual recognition techniques;
determining and presenting, by an artificial intelligence (AI) merchandizing module, best facets of the catalog and featured products and promotions to the customer based on their profile, historical data, and expressed needs;
determining, by the artificial intelligence (AI) merchandizing module, best featured products or promotions to the customer based on profile, historical data, expressed needs, or a combination thereof;
enabling, by a conversational commerce module, customers to interact with a virtual assistant to find, choose, and purchase products through guided conversation;
requesting and presenting, by a personalization module, the best facets, categories, and products to customers based on their profile and needs;
tracking, by a data collection and analytics module, conversations and navigation, analyse performance, and generate data for optimization; and
enabling, by a training and optimization module, administrators to fine-tune the large language model (LLM) based on insights generated from data analytics and to reevaluate facets and merchandizing using the updated large language model (LLM).

9. The method of claim 8, comprising anonymizing customer data to ensure compliance with privacy regulations.

10. The method of claim 8, comprising injecting, by a facet enrichment module, facet characteristics, and descriptions into a large language model (LLM) to create typical buyers' profile for each facet.

11. The method of claim 8, comprising providing real-time inventory updates to customers during their interaction with the virtual assistant.

12. The method of claim 8, comprising offering personalized promotions based on customer behaviour and preferences.
